(19) United States
(12) Patent Application Publication
(10) Pub. No.: US 2010/0053406 A1
(43) Pub. Date: Mar. 4, 2010

(54) SOLID-STATE IMAGE SENSOR AND IMAGING DEVICE

(75) Inventor: Motoari OTA, Kanagawa (JP)

Correspondence Address: Studebaker & Brackett PC, One Fountain Square, 11911 Freedom Drive, Suite 750, Reston, VA, 20190, US

(73) Assignee: FUJIFILM CORPORATION, Tokyo (JP)

(21) Appl. No.: 12/549,977

(22) Filed: Aug. 28, 2009

(30) Foreign Application Priority Data
Aug. 29, 2008 (JP) P2008-222744

(51) Int. Cl. H04N 5/335

(52) U.S. Cl. 348/311; 348/E05.091

(57) ABSTRACT

A solid-state image sensor includes: photoelectric conversion section; a floating gate provided above a semiconductor substrate; a first transistor for accumulating charge generated in said photoelectric conversion section into said floating gate; and a second transistor for reading a signal corresponding to the charge accumulated in said floating gate. A distance between a gate electrode of said first transistor and said floating gate is shorter than a distance between a gate electrode of said second transistor and said floating gate.

### CROSS-REFERENCE TO RELATED APPLICATIONS

This application is based on and claims priority under 35 USC 119 from Japanese Patent Application No. 2008-222744 filed on Aug. 29, 2009; the entire contents of which are incorporated herein by reference.

### BACKGROUND

1. Technical Field

Devices consistent with the present invention relate to a solid-state image sensor including: a photoelectric conversion section; a floating gate provided above a semiconductor substrate; a first transistor for accumulating charge generated in the photoelectric conversion section into the floating gate; and a second transistor for reading a signal corresponding to the charge accumulated in the floating gate.

2. Related Art

A solid-state imaging device has been proposed in which charge generated in a photoelectric conversion element such as a photodiode (PD) is injected and recorded into a floating gate (FG) by a write transistor among a write transistor and a read transistor that share the FG, and then a signal corresponding to the charge recorded in the FG is read to the outside by the read transistor so that image pick-up is performed (see Patent document 1 (JP-A-2002-280537)).

Further, an optical storage device has been proposed that is constructed by connecting photoconductive cells to flash memory cells (see Patent Document 2 (JP-A-6-060683)). In this device, the signal current of a photoconductive cell is written into a floating gate, and then a change in the threshold voltage of a MOS transistor is detected so that the signal of the photoconductive cell is detected.

In Patent Document 2, signal detection is performed by one transistor. Thus, a large error is caused in the signal detection. In contrast, according to the element described in Patent Document 1, signal detection is performed by two transistors, and hence an error in the signal detection is reduced.

Here, like in Patent Document 1, when a write transistor and a read transistor are employed, improvement in the efficiency of charge injection into the FG performed by the write transistor and improvement in the signal detection sensitivity of the read transistor are desired.

### SUMMARY

The present invention has been devised in view of the above-mentioned situation. Illustrative aspects of the present invention provide a solid-state image sensor in which improvement in the efficiency of charge injection into the FG and improvement in the detection sensitivity of a signal corresponding to the charge accumulated in the FG are achieved.

[1] According to an aspect of the invention, a solid-state image sensor includes: a photoelectric conversion section; a floating gate provided above a semiconductor substrate; a first transistor for accumulating charge generated in the photoelectric conversion section into the floating gate; and a second transistor for reading a signal corresponding to the charge accumulated in the floating gate, wherein a distance between a gate electrode of the first transistor and the floating gate is shorter than the distance between a gate electrode of the second transistor and the floating gate.

According to this configuration, the distance between the gate electrode of the first transistor and the floating gate is reduced as much as possible, so that the efficiency of charge injection into the floating gate performed by the first transistor is improved. On the other hand, the distance between the gate electrode of the second transistor and the floating gate is increased as much as possible, so that a change in the amount of charge accumulated in the floating gate is reflected with sensitivity in a change in the threshold voltage of the second transistor and hence the signal detection sensitivity is improved.

[2] According to the solid-state image sensor of [1], in an oxide film formed between the floating gate and the semiconductor substrate, at least a part of the oxide film in a region overlapping with the gate electrode of the first transistor may be formed thinner than the oxide film in a region overlapping with the gate electrode of the second transistor.

According to this configuration, charge is easily injected from the oxide film under the gate electrode of the first transistor into the floating gate. Thus, the charge injection efficiency is improved further. On the other hand, the oxide film under the gate electrode of the second transistor is allowed to be formed in a sufficient thickness that prevents the charge from flowing out from the floating gate. Thus, the floating gate can reliably hold the charge.

[3] According to the solid-state image sensor of [1], the solid-state image sensor may include a charge deletion electrode for extracting and deleting the charge accumulated in the floating gate.

According to this configuration, for example, in comparison with a configuration that the charge in the floating gate is extracted into the semiconductor substrate, influence to the element in the semiconductor substrate is reduced.

[4] According to the solid-state image sensor of [3], the charge deletion electrode may be provided close to the floating gate with an insulating film in between, and the insulating film formed between the floating gate and the charge deletion electrode may have a thickness of an extent that allows the charge in the floating gate to move to the charge deletion electrode by tunneling.

[5] According to the solid-state image sensor of [1], the photoelectric conversion section may be composed of a photoelectric conversion layer provided above the semiconductor substrate, and a source region of the first transistor may be electrically connected to the photoelectric conversion layer. According to this configuration, the efficiency of light utilization is improved.

[6] According to the solid-state image sensor of [5], the photoelectric conversion layer may be composed of amorphous silicon, a CIGS (copper-indium-gallium-selenium)-family material, or an organic material.

[7] According to another aspect of the invention, a solid-state image sensor includes: a photoelectric conversion section; a charge storage part provided above a semiconductor substrate; and a transistor for accumulating charge generated in the photoelectric conversion section into the charge storage part, wherein the photoelectric conversion section is composed of a photoelectric conversion layer provided above the semiconductor substrate, and a source region of the transistor is electrically connected to the photoelectric conversion layer.

[8] According to the solid-state image sensor, an imaging device may employ the solid-state image sensor of [1] or [7].

According to [1] to [8], a solid-state image sensor is provided in which improvement in the efficiency of charge injection into the FG and improvement in the detection sensitivity of a signal corresponding to the charge accumulated in the FG are achieved.

### BRIEF DESCRIPTION OF THE DRAWINGS

FIG. 1 is a schematic diagram showing a schematic configuration of a solid-state image sensor and used for describing an embodiment of the present invention.

FIG. 2 is a schematic diagram showing a schematic configuration of a pixel part of a solid-state image sensor shown in FIG. 1.

FIG. 3 is a timing chart showing operation of still image pick-up performed by an imaging device employing a solid-state image sensor shown in FIG. 1.

FIG. 4 is a diagram showing a first another exemplary configuration of a solid-state image sensor shown in FIG. 1.

FIG. 5 is a diagram showing a second another exemplary configuration of a solid-state image sensor shown in FIG. 1.

FIG. 6 is a timing chart showing operation of still image pick-up performed by an imaging device employing a solid-state image sensor according to a second another exemplary configuration of a solid-state image sensor shown in FIG. 1.

### DETAILED DESCRIPTION

A solid-state image sensor adopted for describing the exemplary embodiments of the present invention is described below with reference to the drawings. This solid-state image sensor is to be mounted on an imaging device such as a digital camera and a digital video camera.

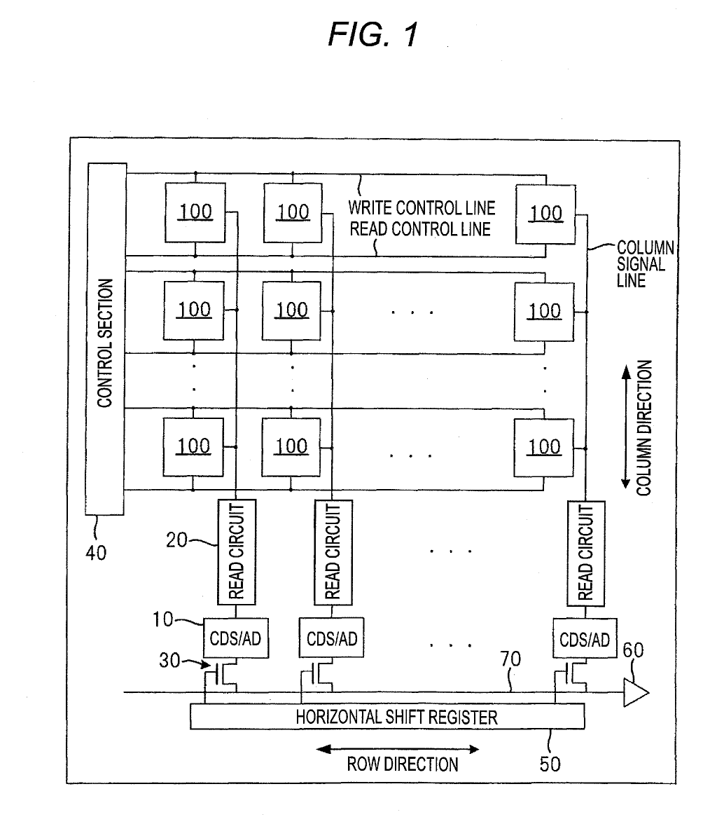

FIG. 1 is a schematic plan-view diagram showing a schematic configuration of a solid-state image sensor and used for describing an embodiment of the present invention. The imaging device shown in FIG. 1 has a large number of pixel parts 100 arranged in the shape of an array (a square grid, in this example) consisting of a row direction in the same plane and a column direction perpendicular to the row direction.

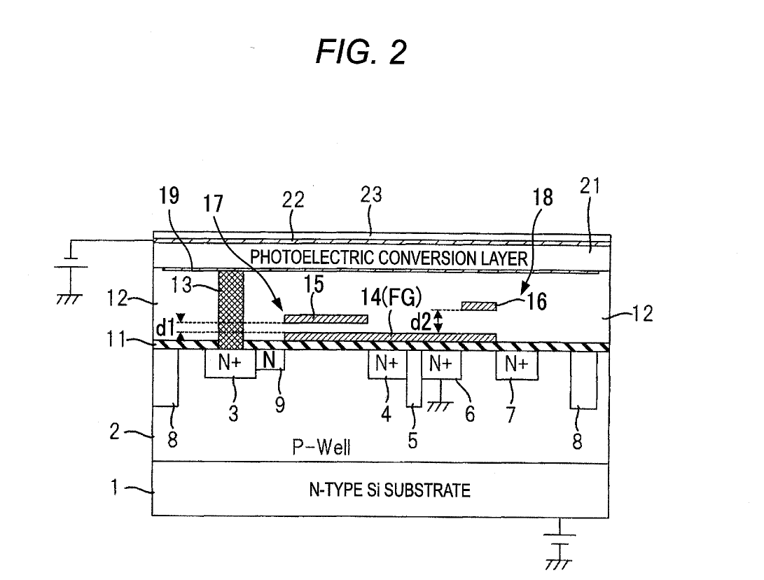

FIG. 2 is a schematic diagram showing a schematic configuration of a pixel part of the solid-state image sensor shown in FIG. 1.

Above a semiconductor substrate (such as an N-type silicon substrate) 1 of each pixel part 100, a pixel electrode 19 separated for each pixel part 100 is formed. A photoelectric conversion layer 21 is formed on the pixel electrode 19. Then, an opposite electrode 22 is formed on the photoelectric conversion layer 21. On the opposite electrode 22, a protective layer 23 transparent to incident light is formed.

The opposite electrode 22 is composed of a conductive material (such as ITO) that transmit incident light. A single sheet of this electrode is shared by all pixel parts 100. The photoelectric conversion layer 21 is a layer containing an organic or inorganic photoelectric conversion material for generating charge in response to incident light. A single sheet of this layer is shared by all pixel parts 100. The photoelectric conversion layer 21 may be, for example, composed of amorphous silicon and a CIGS (copper-indium-gallium-selenium)-family material.

The opposite electrode 22 and the photoelectric conversion layer 21 may be formed separately for each pixel part 100.

In the semiconductor substrate 1, a p-well layer 2 is formed. Then, within the p-well layer 2, a charge storage part 3 is formed that is composed of a high-concentration n-type impurity layer electrically connected to the photoelectric conversion layer 21.

The charge storage part 3 is connected to the pixel electrode 19 through a plug 13 buried in an oxide film 11 such as a silicon oxide film provided on the semiconductor substrate 1 and in an insulating film 12 such as an oxide film and a nitride film. This provides electric connection to the photoelectric conversion layer 21.

In the semiconductor substrate 1, a read section is formed that can read to the outside a voltage signal (also referred to as an imaging signal, hereinafter) corresponding to the charge generated in the photoelectric conversion section 3.

The read section has a write transistor (WT, hereinafter) 17 and a read transistor (RT, hereinafter) 18. The WT 17 and the RT 18 are isolated from each other by an isolation region 5 arranged with small spacing in the right-hand-side vicinity of the photoelectric conversion section 3. Further, each pixel part 100 in the semiconductor substrate 1 is isolated from the other by an isolation region 8.

Employable device isolation methods include a LOCOS (Local Oxidation of Silicon) method, an STI (Shallow Trench Isolation) method, and a method employing high-concentration impurities ion implantation.

The WT 17 has a MOS transistor structure provided with: a source region 9 composed of an n-type impurity layer arranged with spacing adjacent to the charge storage part 3; a drain region 4 arranged with spacing on the right of the source region 9; and a gate electrode 15 provided above the semiconductor substrate 1 between the source region 9 and the drain region 4. A power supply capable of supplying a constant voltage is connected to the drain region 4 of the WT 17.

The conductive material constituting the gate electrode 15 may be, for example, polysilicon. Alternatively, doped polysilicon may be employed in which phosphorus (P), arsenic (As), or boron (B) is doped at high concentration. Further, silicide (Silicide) or salicide (Self-align Silicide) may be employed in which various kinds of metals such as titanium (Ti) and tungsten (W) are combined with silicon.

The RT 18 has a MOS transistor structure provided with: a source region 6 provided in the right-hand-side vicinity of the isolation region 5; a drain region 7 arranged with small spacing in the right-hand-side vicinity of the source region 6; and a gate electrode 16 provided above the semiconductor substrate 1 between the source region 6 and the drain region 7. The source region 6 is grounded. The conductive material constituting the gate electrode 16 may be the same as that of the gate electrode 15.

Above the semiconductor substrate 1 between the source region 9 and the drain region 7, a floating gate (FG, hereinafter) 14 which is an electrically floating electrode is provided via the oxide film 11. On the FG 14, the gate electrode 15 and the gate electrode 16 are provided via the insulating film 12. The conductive material constituting the FG 14 may be the same as that of the gate electrode 15.

Here, the FG 14 is not limited to a single-sheet configuration common to the WT 17 and the RT 18, and may be provided separately for the WT 17 and the RT 18. Then, the two separate FGs may electrically be connected to each other through wiring.

In the read section, first, in a state that a predetermined voltage is applied on the drain region 4 of the WT 17, a write control voltage (WG) of, for example, 7 V to 15 V is applied on the gate electrode 15 so that the charge generated in the photoelectric conversion layer 21 is injected into the FG 14 via the charge storage part 3 and the source region 9. Further, in a state that a drain voltage at a predetermined level is applied on the drain region 7 of the RT 18, a read control voltage (RG) at a predetermined level is applied on the gate electrode 16 of the RT 18 so that the drain current of the RT 18 is detected. By virtue of this, the detected drain current value is read to the outside as an imaging signal corresponding to the charge accumulated in the FG 14.

Here, in the read section, a method may be adopted in which after the charge is injected into the FG 14 by the above-mentioned method, in a state that a drain voltage of, for example, 3.3 V is applied on the drain region 7 of the RT 18, a read control voltage increasing continuously or stepwise is applied on the gate electrode 16 of the RT 18, and then the value (equal to the threshold voltage of the RT 18) of the read control voltage at the time that the channel region of the RT 18 becomes conductive, so that the detected value of the threshold voltage is read to the outside as an imaging signal corresponding to the charge accumulated in the FG 14.

The configuration of the read section provided with the WT 17 and the RT 18 is described in detail also in Patent Document 1. Thus, this document should be referred to.

In the solid-state image sensor shown in FIG. 1, improvement in the efficiency of charge injection into the FG 14 performed by the WT 17 and improvement in the signal detection sensitivity of the RT 18 are desired.

In order that the charge injection efficiency should be improved, the distance d1 between the gate electrode 15 and the FG 14 measured in a direction perpendicular to the substrate 1 surface need be shortened so that the influence of the electric potential of the gate electrode 15 to the electric potential gradient in the oxide film 11 and the p-well layer 2 under the gate electrode 15 need be increased.

On the other hand, in order that the signal detection sensitivity should be improved, since the relation between the charge present in the FG 14 and the threshold voltage of the RT 18 is given by the following Formula (1), the distance d2 between the FG 14 and the gate electrode 16 measured in a direction perpendicular to the substrate 1 surface need be increased so that a change in the amount of charge in the FG 14 need be reflected with sensitivity in a change in the threshold voltage of the RT 18. When such a configuration is employed that a change in the amount of charge in the FG 14 is reflected with sensitivity in a change in the threshold voltage of the RT 18, the drain current of the RT 18 also varies with sensitivity and hence the signal detection sensitivity is improved.

ΔVth=−(ΔQfg/ε)×d2 Formula (1)

ΔVth: the amount of change in the threshold voltage of the RT 18

ΔQfg: the amount of change in the charge present in the FG 14

ε: the dielectric constant of the material of the insulating film 12 formed between the FG 14 and the gate electrode 16

Thus, when the distances from the FG 14 to the gate electrode 15 and to the gate electrode 16 are equal to each other, improvement in the charge injection efficiency and improvement in the signal detection sensitivity cannot simultaneously be achieved. Accordingly, in the solid-state image sensor shown in FIG. 1, the distance d1 between the FG 14 and the gate electrode 15 and the distance d2 between the FG 14 and the gate electrode 16 are formed different from each other (d1<d2).

According to this configuration, the distance d1 is minimized to an extent that insulation between the FG 14 and the gate electrode 15 is maintained and that tunneling of the charge in the FG 14 to the gate electrode 15 is prevented. Further, the distance d2 is maximized to an extent that a sufficient electric potential acts on the channel of the RT 18 under the gate electrode 16. As a result, improvement in the charge injection efficiency and improvement in the signal detection sensitivity are achieved simultaneously.

The solid-state image sensor shown in FIG. 1 further includes: a control section 40; a read circuit 20 for detecting the drain current of the RT 18; a CDS/AD 10 for performing correlation double sampling (CDS) processing and AD conversion processing onto the drain current detected by the read circuit 20; a horizontal shift register 50 for performing control such that the imaging signal outputted from the CDS/AD 10 is sequentially read onto a signal line 70; and an output buffer 60 connected to the signal line 70.

The read circuit 20 is provided in correspondence to each column composed of a plurality of pixel parts 100 arranged in the column direction, and is connected to the drain region 7 of each pixel part 100 of the corresponding column via the column signal line.

The read circuit 20 applies a read control voltage (RG) onto the gate electrode 16 of the RT 18 via the control section 40, and then outputs the current value of the drain region 7 obtained as a result, as an imaging signal to the CDS/AD 10.

When one horizontal selection transistor 30 is selected by the horizontal shift register 50, the imaging signal outputted from the CDS/AD 10 connected to the horizontal selection transistor 30 is outputted to the signal line 70 and then outputted from the output buffer 60.

The control section 40 is connected through a write control line to the gate electrode 15 of each pixel part 100 of a line composed of a plurality of pixel parts 100 arranged in the row direction, and is connected through a read control line to the gate electrode 16 of each pixel part 100 of the line.

The control section 40 performs: storage control in which a write control voltage (WG) is applied simultaneously onto the gate electrode 15 of the WT 17 of each pixel part 100 so that the charge generated in each photoelectric conversion layer 21 is accumulated into the FG 14 at the same timing; RG application control in which the read control voltage (RG) provided from the read circuit 20 is applied onto the gate electrode 16 of the RT18 independently for each line; and charge deletion control in which the charge accumulated in the FG 14 of each pixel part 100 is deleted. The write control voltage (WG) may be generated by a charge pump circuit (not shown) for stepping up the supply voltage.

The method of charge deletion may be, for example, a method in which a negative voltage is applied onto the gate electrode 15 and the gate electrode 16 so that the charge in the FG 14 is extracted into the semiconductor substrate 1.

Image pick-up operation performed by the solid-state image sensor 10 is described below.

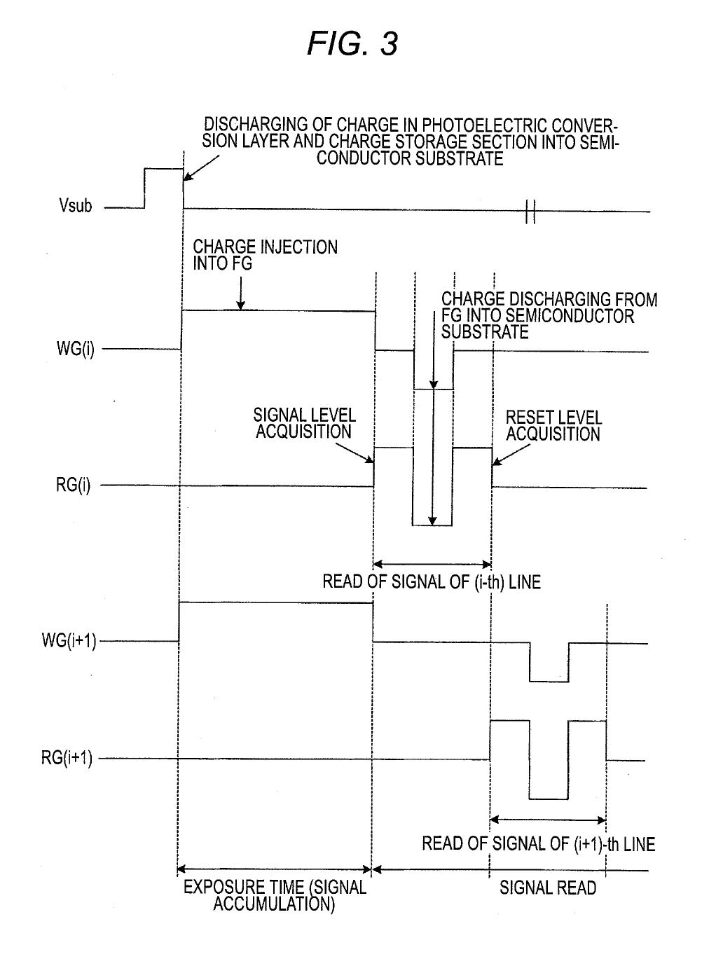

FIG. 3 is a timing chart showing the operation of still image pick-up performed by an imaging device employing the solid-state image sensor shown in FIG. 1. In video image pick-up performed in a still image pick-up mode, when setup instruction (half press of the shutter button) for image pick-up conditions for still image pick-up is performed, the control section 40 performs AE and AF on the basis of the imaging signal outputted from the solid-state image sensor so as to set up image pick-up conditions.

Then, when the shutter button is fully pressed and hence the shutter trigger rises, the control section 40 starts still image pick-up with the above-mentioned image pick-up conditions having been set up.

Specifically, immediately before the exposure time based on the above-mentioned image pick-up conditions having been set up, the control section 40 performs electronic shutter operation of applying a high voltage onto the semiconductor substrate 1 so as to discharge to the semiconductor substrate side the charge generated in the photoelectric conversion layer 21 and accumulated in the charge storage part 3 and the source region 9.

When the shutter trigger has risen and the exposure start timing has arrived, the control section 40 provides the WG to all gate electrodes 15. Then, at the exposure end timing, the control section 40 stops providing the WG to all gate electrodes 15. The WG(i) shown in FIG. 3 expresses the WG applied on the i-th line. The WG(i+1) expresses the WG applied on the (i+1)-th line. As a result of such operation, the charge generated in the photoelectric conversion layer 21 of each pixel part 100 during the exposure time is accumulated into the FG 14 of each pixel part 100.

After the completion of exposure time, the control section 40 starts providing the RG to each pixel part 100 of the i-th (=1st) line. The RG(i) shown in FIG. 3 expresses the RG applied on the i-th line. The RG(i+1) expresses the RG applied on the (i+1)-th line. After the start of providing the RG, the drain current (signal level) of the RT 18 of each pixel part 100 of the i-th (=1st) line is detected by the read circuit 20. This result is inputted to the CDS/AD 10, and then sampled and held.

Then, the control section 40 applies a negative deletion voltage onto the gate electrode 15 and the gate electrode 16 of each pixel part 100 of the i-th (=1st) line. As a result, the charge accumulated in the FG 14 of each pixel part 100 of the i-th (=1st) line is discharged into the semiconductor substrate 1 so as to be deleted.

Then, the control section 40 starts providing the RG again to each pixel part 100 of the i-th (=1st) line. After the start of providing the RG, the drain current (reset level) of the RT 18 of each pixel part 100 of the i-th (=1st) line is detected by the read circuit 20. This result is inputted to the CDS/AD 10, and then sampled and held.

In the CDS/AD 10, the reset level is subtracted from the sampled signal level, and then the result is converted into a digital signal. Then, under the control of the horizontal shift register 50. This digital signal value is sequentially outputted as an imaging signal acquired from each pixel part 100 of the i-th (=1st) line.

Also in the (i+1)-th (=2nd) and subsequent lines, the above-mentioned operation (providing of the RG to each pixel part 100 of the corresponding line, output of the signal level, deletion of the charge in the FG 14 of the corresponding line, providing of the RG to each pixel part 100 of the corresponding line, and output of the reset level) is performed so that the still image pick-up is completed.

As described above, according to the solid-state image sensor shown in FIG. 1, the distance between the gate electrode 15 and the FG 14 is minimized and the distance between the gate electrode 16 and the FG 14 is maximized. Thus, improvement in the charge injection efficiency and improvement in the signal detection sensitivity are achieved simultaneously.

Here, the n-type impurity layer 9 shown in FIG. 2 may be omitted, and the charge storage part 3 may be implemented by the source region of the WT 17. When the n-type impurity layer 9 is provided, the dark current generated in the charge storage part 3 becomes difficult to flow into the channel under the FG 14, and hence the S/N is improved.

The following description is given for other exemplary configurations of the solid-state image sensor shown in FIG. 1.

(First Another Exemplary Configuration)

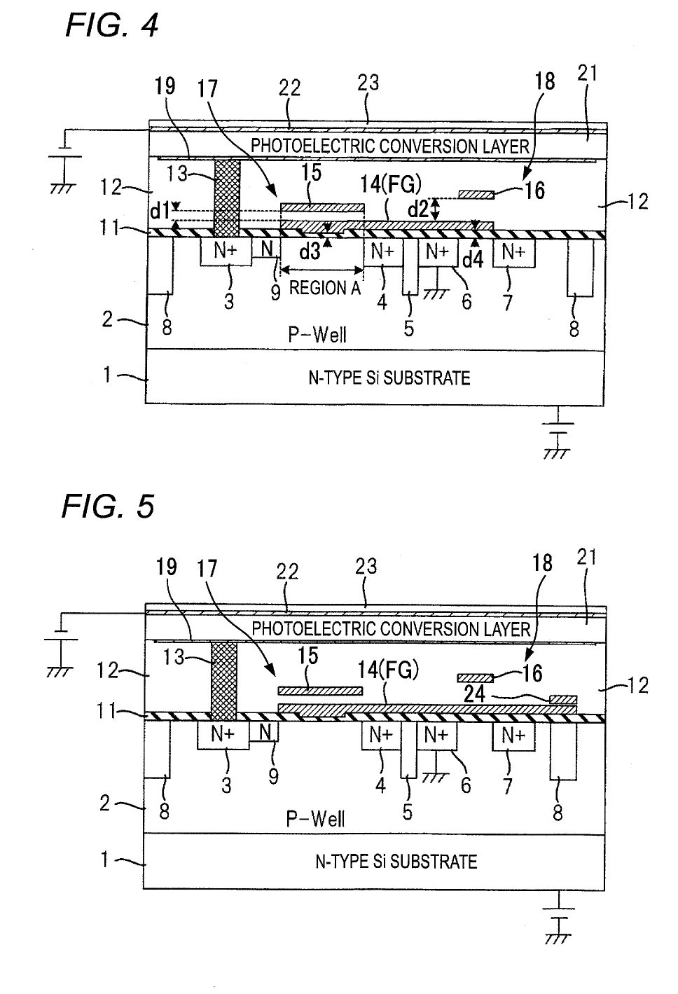

FIG. 4 is a diagram showing a first another exemplary configuration of the solid-state image sensor shown in FIG. 1. This figure shows a schematic cross sectional view of one pixel part.

In the solid-state image sensor shown in FIG. 4, in the oxide film 11 formed between the FG 14 and the semiconductor substrate 1 of the solid-state image sensor shown in FIG. 2, at least a part of the oxide film 11 in a region (region A) overlapping with the gate electrode 15 is formed thinner than the oxide film 11 in a region overlapping with the gate electrode 16.

The efficiency of charge injection into the FG 14 increases with decreasing distance between the FG 14 and the semiconductor substrate 1, that is, with decreasing thickness of the oxide film 11. Nevertheless, in a case that the oxide film 11 is formed excessively thin, when a voltage is applied on the gate electrode 16, charge flows into the FG 14 from the semiconductor substrate 1 side. This causes fluctuation in the amount of charge in the FG 14, and hence results in a possible signal error. Thus, in the solid-state image sensor according to the first another exemplary configuration, the oxide film 11 measured in a direction perpendicular to the substrate 1 surface is formed in a thickness (d4) of an extent that tunneling of the charge does not occur when the RG is applied on the gate electrode 16. Then, only in the region A where tunneling of the charge should be generated intentionally, at least a part of the region is formed in a thickness d3 smaller than d4.

According to this configuration, the charge injection efficiency is improved further.

(Second Another Exemplary Configuration)

FIG. 5 is a diagram showing a second another exemplary configuration of the solid-state image sensor shown in FIG. 1. This figure shows a schematic cross sectional view of one pixel part.

The solid-state image sensor shown in FIG. 5 has a configuration that the charge deletion electrode 24 for extracting and deleting the charge accumulated in the FG 14 is provided in each pixel part 100 of the solid-state image sensor shown in FIG. 4. The material of the charge deletion electrode 24 may be the same as that of the gate electrode 15.

The FG 14 formed such as to extend above the isolation region 8. Then, the charge deletion electrode 24 is provided above of the FG 14 in the part where the FG 14 and the isolation region 8 overlap with each other.

The charge deletion electrode 24 need apply a high voltage for charge deletion. Thus, the charge deletion electrode 24 is provided above the isolation region 8 so that a short circuit is avoided. Here, it is especially preferable that the isolation region 8 is formed by an STI method. When the isolation region 8 is formed by a method such as ion implantation other than the STI method, in order that a short circuit should be avoided, a thick oxide film formed by CVD or the like is necessary between the isolation region 8 and the charge deletion electrode 24. In contrast, when the isolation region 8 is formed by the STI method, the thick oxide film is unnecessary and hence this contributes to thickness reduction in the solid-state image sensor.

It is sufficient that the insulating film 12 formed between the charge deletion electrode 24 and the FG 14 has a thickness (for example, 100 Å or less) of an extent that insulation performance between the charge deletion electrode 24 and the FG 14 is maintained and that when a voltage (deletion voltage, hereinafter) necessary for deleting the charge in the FG 14 is applied onto the charge deletion electrode 24, the charge in the FG 14 is allowed to move to the charge deletion electrode 24 by tunneling. Here, in order that the efficiency of the charging tunneling should be improved, it is preferable that small recesses and protrusions are provided in the surface of the FG 14 opposite to the charge deletion electrode 24 as disclosed in the specification of U.S. Pat. No. 4,274,012. Alternatively, a configuration may be adopted that small recesses and protrusions are provided in the surface of the charge deletion electrode 24 opposite to the FG 14.

Image pick-up operation performed by the solid-state image sensor according to the second exemplary configuration is described below.

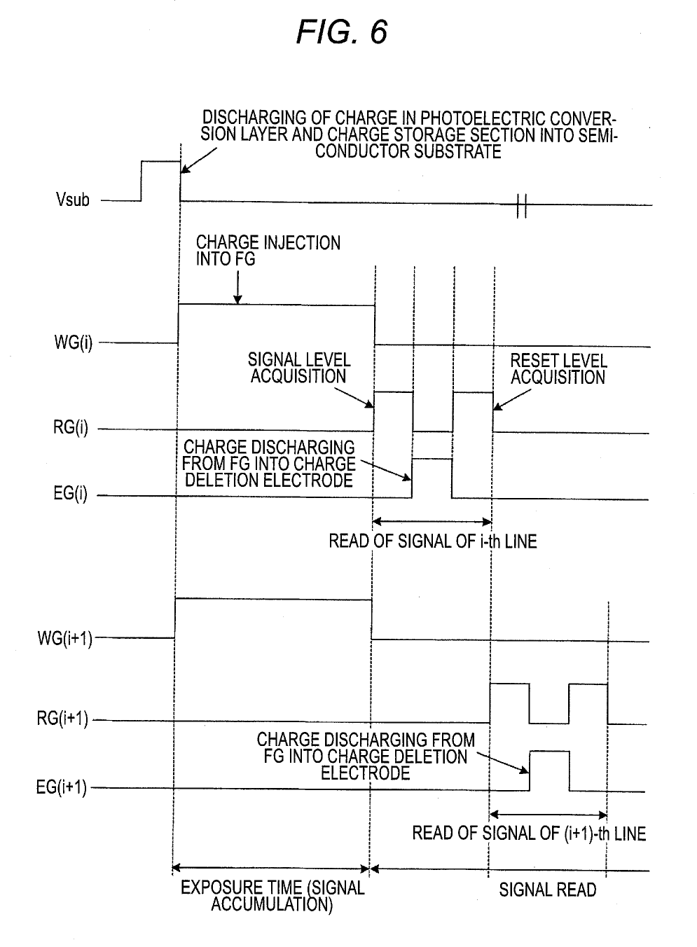

FIG. 6 is a timing chart showing the operation of still image pick-up performed by an imaging device employing the solid-state image sensor according to the second another exemplary configuration of the solid-state image sensor shown in FIG. 1. In video image pick-up performed in a still image pick-up mode, when setup instruction (half press of the shutter button) for image pick-up conditions for still image pick-up is performed, the control section 40 performs AE and AF on the basis of the imaging signal outputted from the solid-state image sensor so as to set up image pick-up conditions.

Then, when the shutter button is fully pressed and hence the shutter trigger rises, the control section 40 starts still image pick-up with the above-mentioned image pick-up conditions having been set up.

Specifically, immediately before the exposure time based on the above-mentioned image pick-up conditions having been set up, the control section 40 performs electronic shutter operation of applying a high voltage onto the semiconductor substrate 1 so as to discharge to the semiconductor substrate side the charge generated in the photoelectric conversion layer 21 and accumulated in the charge storage part 3 and the source region 9.

When the shutter trigger has risen and the exposure start timing has arrived, the control section 40 provides the WG to all gate electrodes 15. Then, at the exposure end timing, the control section 40 stops providing the WG to all gate electrodes 15. The WG(i) shown in FIG. 6 expresses the WG applied on the i-th line. The WG(i+1) expresses the WG applied on the (i+1)-th line. As a result of such operation, the charge generated in the photoelectric conversion layer 21 of each pixel part 100 during the exposure time is accumulated into the FG 14 of each pixel part 100.

After the completion of exposure time, the control section 40 starts providing the RG to each pixel part 100 of the i-th (=1st) line. The RG(i) shown in FIG. 3 expresses the RG applied on the i-th line. The RG(i+1) expresses the RG applied on the (i+1)-th line. After the start of providing the RG, the drain current (signal level) of the RT 18 of each pixel part 100 of the i-th (=1st) line is detected by the read circuit 20. This result is inputted to the CDS/AD 10, and then sampled and held.

Then, the control section 40 applies a positive deletion voltage onto the charge deletion electrode 24 of each pixel part 100 of the i-th (=1st) line. As a result, the charge accumulated in the FG 14 of each pixel part 100 of the i-th (=1st) line is discharged into the charge deletion electrode 24 so as to be deleted.

Then, the control section 40 starts providing the RG again to each pixel part 100 of the i-th (=1st) line. After the start of providing the RG, the drain current (reset level) of the RT 18 of each pixel part 100 of the i-th (=1st) line is detected by the read circuit 20. This result is inputted to the CDS/AD 10, and then sampled and held.

In the CDS/AD 10, the reset level is subtracted from the sampled signal level, and then the result is converted into a digital signal. Then, under the control of the horizontal shift register 50. This digital signal value is sequentially outputted as an imaging signal acquired from each pixel part 100 of the i-th (=1st) line.

Also in the (i+1)-th (=2nd) and subsequent lines, the above-mentioned operation (providing of the RG to each pixel part 100 of the corresponding line, output of the signal level, deletion of the charge in the FG 14 of the corresponding line, providing of the RG to each pixel part 100 of the corresponding line, and output of the reset level) is performed so that the still image pick-up is completed.

As described above, according to the solid-state image sensor of the second exemplary configuration, the charge in the FG 14 is deleted by the charge deletion electrode 24. Thus, in comparison with a method that the charge in the FG 14 is discharged into the semiconductor substrate 1, erroneous operation of the transistor in the semiconductor substrate 1 is prevented. Further, a situation is avoided that the deleted charge flows into the charge storage part 3 so as to cause a noise. This reduces a signal detection error.

Further, the charge deletion electrode 24 is provided above the isolation region 8. Thus, the electric field generated by the charge deletion electrode 24 hardly affects the operation of the element in the semiconductor substrate 1, and hence the reliability of the element is improved. When the isolation region 8 is formed by an STI method, thickness reduction is also achieved in the solid-state image sensor.

Further, the FG 14, the gate electrode 15, the gate electrode 16, and the charge deletion electrode 24 are all formed from a material that contains polysilicon. This permits thickness reduction in the insulating film for insulating these. Further, micro processing becomes easy. Thus, thickness reduction and minimum-line-width reduction are easily achieved in the solid-state image sensor.

Here, the above-mentioned description has been given for a case that the charge deletion electrode 24 is added to the configuration shown in FIG. 4. However, another configuration may be adopted that the charge deletion electrode 24 is added to the configuration shown in FIG. 2.

Further, the above-mentioned description has been given for a configuration that the charge generated in the photoelectric conversion layer 21 provided above the semiconductor substrate 1 is injected into the FG 14. However, another configuration may be adopted that the pixel electrode 19, the photo electric conversion layer 21, the opposite electrode 22, and the plug 13 are omitted and that a p-n junction photodiode is formed by the charge storage part 3. When the configuration shown in FIG. 2 is adopted, an open aperture ratio of approximately 100% is obtained so that the efficiency of light utilization is improved. Thus, this configuration is advantageous in sensitivity enhancement and the like.

Further, the above-mentioned description has been given for a case that the handling charge (charge extracted as a signal) is of electrons. However, even when the handling charge is of holes, the principles are the same. When the handling charge is of holes, it is sufficient that the N-region and the P-region are interchanged and that the polarity of the voltage applied on each part is reversed.

What is claimed is:

1. A solid-state image sensor comprising:
a photoelectric conversion section;
a floating gate provided above a semiconductor substrate;
a first transistor for accumulating charge generated in said photoelectric conversion section into said floating gate; and
a second transistor for reading a signal corresponding to the charge accumulated in said floating gate, wherein
a distance between a gate electrode of said first transistor and said floating gate is shorter than a distance between a gate electrode of said second transistor and said floating gate.

2. The solid-state image sensor according to claim 1, wherein
in an oxide film formed between said floating gate and said semiconductor substrate, at least a part of said oxide film in a region overlapping with the gate electrode of said first transistor is formed thinner than said oxide film in a region overlapping with the gate electrode of said second transistor.

3. The solid-state image sensor according to claim 1, further comprising:
a charge deletion electrode for extracting and deleting the charge accumulated in said floating gate.

4. The solid-state image sensor according to claim 3, wherein
said charge deletion electrode is provided close to said floating gate with an insulating film in between, and
said insulating film formed between said floating gate and said charge deletion electrode has a thickness of an extent that allows the charge in said floating gate to move to said charge deletion electrode by tunneling.

5. The solid-state image sensor according to claim 1, wherein
said photoelectric conversion section is composed of a photoelectric conversion layer provided above said semiconductor substrate, and
a source region of said first transistor is electrically connected to said photoelectric conversion layer.

6. The solid-state image sensor according to claim 5, wherein
said photoelectric conversion layer is composed of amorphous silicon, a CIGS (copper-indium-gallium-selenium)-family material, or an organic material.

7. A solid-state image sensor comprising:
a photoelectric conversion section;
a charge storage part provided above a semiconductor substrate; and
a transistor for accumulating charge generated in said photoelectric conversion section into said charge storage part, wherein
said photoelectric conversion section is composed of a photoelectric conversion layer provided above said semiconductor substrate, and
a source region of said transistor is electrically connected to said photoelectric conversion layer.

8. An imaging device employing the solid-state image sensor according to claim 1.

9. An imaging device employing the solid-state image sensor according to claim 7.
